(19) United States
(12) Patent Application Publication
(10) Pub. No.: US 2011/0108506 A1
(43) Pub. Date: May 12, 2011

(54) Drink bottle

(76) Inventor: Gwenda Lindhorst-Ko, Ottawa (CA)

(21) Appl. No.: 12/925,941

(22) Filed: Nov. 2, 2010

Related U.S. Application Data
(60) Provisional application No. 61/257,103, filed on Nov. 2, 2009.

(51) Int. Cl. A47J 41/00; B23P 17/04

(52) U.S. Cl. 215/13.1; 29/428

(57) ABSTRACT

A stainless steel vacuum drink container able to keep liquids at a refrigerated state for a minimum of 5 hrs. The bottle includes a stainless steel double wall vacuum insulated bottle with a freezer component, attached to the lid, and optimally placed in the liquid for the thermal exchange to keep the liquid refrigerated.

### RELATED APPLICATIONS

This application claims the benefit of priority to copending U.S. Provisional Patent Application No. 61/257,103 filed Nov. 2, 2009 by the same inventor, which is incorporated herein by reference in its entirety.

### FIELD OF THE INVENTION

The present invention relates to drink bottles and is particularly concerned with maintaining contents at a cool temperature.

### BACKGROUND OF THE INVENTION

Milk has the most stringent temperature requirements of any beverage due to bacterial content in the milk. If left out at room temperature it will spoil and after 2 hrs should be discarded. Commercial transport of milk is required by law to maintain the temperature below 45° F.(7° C.). However, once in the consumer's hands, they have no means of storing or transporting milk for longer than a short time of about 2 hrs, without running the risk of spoilage due to harmful bacterial growth. This is a concern for mothers of small children during day time outings and also for children taking milk to school for their lunch. Typically, children do not take milk to school in their lunch bag because of spoilage concerns and the fact that milk, does not taste good when warm. In order to have milk for lunch, it must be served from the school cafeteria, a lunch milk program, or from vending machines. This limits the choice for the child, especially for children who are lactose intolerant, or those who prefer organic milk, goat milk or soy drink. Also, for some children, milk bought at school may be too expensive, and some schools may not provide milk for sale or via a milk program. Having a compact, lightweight, portable container that is rated to keep milk fridge cold for 6 or more hrs would allow more options for mothers and children. A time length of 6 hrs is would be sufficient as this is the maximum time between packing a lunch at 8 am and the last possible school lunch time of 2 pm. The application of the current invention is certainly not limited to these two examples. Other examples may include adults who wish to take smoothies, iced tea, or other beverages for their lunch at work.

Refrigerated milk is not only a safety requirement it is also a matter of taste. Milk is one beverage for which the temperature really makes a difference in the taste. Even a few degrees can make a noticeable difference.

Another challenge in keeping milk cold is the fact that the specific heat of milk is 0.92 Btu, which means that 92 Btu will be needed to raise 100 lbs of milk by 1° F. The specific heat of water is 1 Btu. Thus if the surrounding temperature is room temperature, the temperature of milk will rise quicker than for the same volume of water. All of these factors increase the difficulty of keeping milk at a safe temperature.

Referring to FIG. 1 there is graphically illustrated the temperature ranges for bacterial growth.

There have been a number of approaches for solving the problem of transporting perishable food, especially milk.

One approach is an insulated container that requires active refrigeration. The source of energy for such can be thermoelectric (App US 2004/0194470; U.S. Pat. No. 5,572,872), battery, fuel cell or solar panel (U.S. Pat. No. 4,006,606; U.S. Pat. No. 6,751,963). As can be quickly seen, such would not be useful for packing with a child's lunch or for anyone wishing to take a refrigerated drink with them for the day. They are too large and unwieldy. Not only are they not designed for such a use, even if they were reduced in size, they would still be considered ‘large’ for the intended use.

Referring to FIG. 2 there is graphically illustrated the temperature rises as a function of time for various prior art containers. For all discussion, it is assumed that the drink, when poured into the container, starts at a refrigerated temperature of max 40° F. (4° C.). The ambient temperature for all testing was 70° F. (21° C.). The beverage in all containers, without some form of active refrigeration, will simply rise in temperature over time. How quickly the temperature rises will be dependent on the insulation properties of the container.

Another approach is to place freezer or gel packs around the milk within an insulated storage compartment. Such concepts are most often presented for cooler systems for carrying milk bottles for babies. (U.S. Pat. Nos. 4796758; 6,427,475; App US 2006/0283205) Some parents do employ a similar method to send their child's milk to school. They put the milk in a container which is then placed on a gel pack and packed in the insulated lunch bag along with the other food. This however, is not sufficient to keep the milk refrigerated. (see FIG. 2 graph #5)

Yet another approach is to design a container which incorporates the freezer component within the walls of the container. (U.S. Pat. Nos. 3,406,532; 5,241,835; App US 2006/0201165) This is not optimal due to thermal losses as will be evident from the discussion of the current invention. Much more freezer material is required to keep the drink refrigerated than is required by the current invention. This excess gel results in a lot of bulk weight which is not desirable for the child/adult who has to carry the lunch bag.

Considering other classifications which may be able to address the requirements, prior art of interest is found with drink bottles, especially those which claim to keep liquids cold. None of these, however, claim to be useful for milk and, having no stringent temperature requirements, only aim to keep the drink ‘cold’ or ‘cold longer’ or even to ‘cool the liquid as one drinks it’.

There are two approaches to keeping the drink cold: 1) improving the insulation properties of the container, and 2) inserting a freezer component into the container. Prior art has considered one or the other of these approaches, but has not combined them or considered an optimal way to do so. These approaches do not attempt to store a drink at refrigeration levels. Their concern is primarily to provide a cold drink to enhance the drinking experience.

Various attempts have been made in improving the insulation properties of the container. Plastic bottles have been made with double walls and air between. This almost has no effect on keeping the liquid cold longer. The layer between the double walled plastic may also have an insulation jacket. This offers some improvement (see FIG. 2 graph #4).

The best insulation is provided by a vacuum, such as found in U.S. Pat. No. 5,153,977 (see FIG. 2 graph#6 or #7). This particular technique is known to provide a superior vacuum with the best insulation possible. From all existing prior art solutions, the stainless steel double walled vacuum bottle gives the best long term results for keeping a liquid cold for many hours. (Glass lined bottles may give better temperature results, but were not considered due to the safely issues, especially since the required container may be used by children.) However, even this best case example of a vacuum insulated container still does not meet the requirements to keep milk refrigerated. Stainless steel double wall vacuum bottles vary in their performance due to the quality of the vacuum, and the construction of the bottle. Bottles with a copper lining within the bottle walls provide better insulation because the copper prevents thermal loss due to radiation. (see FIG. 2, and compare graphs #6 and #7)

The second approach, inserting a freezer component into the container has also been reviewed (see U.S. Pat. No. 7,082,784 see FIG. 2 graph #6).

In the prior art, the freezer component is placed either by inserting from the bottom of the container (U.S. Pat. Nos. 5,467,877, 5,597,087, 6,305,175, 7,010,935, 2005/0103739) or by inserting from the top and/or attached to the lid (U.S. Pat. Nos. 5,129,238, 7,082,784, 2008/0000259). U.S. Pat. Nos. 6,134,894 and 6,305,175 both mention an insulating sleeve on the outside of the container, but this is more of an afterthought and not considered to be part of their invention.

Within the two scenarios (top or bottom entrance of freezer component), are other considerations for technical or physical concerns. When considering the placement of the cooling device, existing patents attempt to address the following concerns: i. Prevention of the cooling device from unexpected movement when the beverage bottle is tilted ii. Placement of the cooling device so that the center of gravity is lower thus preventing the bottle tipping over when empty of liquid (US application 2005/0103739); or iii. Design and placement of the cooling device so that the liquid flows past it, in order to cool the liquid, when the user drinks from the bottle (U.S. Pat. No. 5,009,083). Other considerations include how the freezer component is attached to cap (U.S. Pat. No. 7,082,784, 2008/0000259) and the cooling effects of the freezer component due to shape (U.S. Pat. Nos. 5,357,761, 5,507,156, 5,609,039).

It is evident from the graphs in FIG. 2 that the addition of the freezer component has a greater impact than plastic with an insulator jacket. (see FIG. 2 graphs #5 and #6).

Existing patents, which aim to cool liquids, or keep liquids cold, are only concerned with the freezable insert, and do not also take into consideration the thermal loss of the drink container. This is very significant, and renders the freezable insert of minimal impact (giving an hour or two at refrigeration temperature, certainly not up to 10 hrs). None of these devices address the problems of keeping perishable liquids such as milk in a refrigerated state long enough to be transported for consumption later in the day.

None claim to consider the location of the cooling device to optimize long term cooling of the liquid.

A drink bottle disclosed herein obviates or mitigates at least some of the aforementioned disadvantages.

### SUMMARY OF THE INVENTION

At present, there is no commercially available bottle that keeps drinks within a refrigerated temperature range of 32° F. to 40° F. (0° C. to 4° C.) for an extended number of hours. There is a need for a small, lightweight, compact, easy to use bottle that is able to keep a drink refrigerated for many hours. The bottle should also be simple in design for ease in manufacturing and to minimize cost.

In order to maintain a liquid temperature which remains below 40° F. (4° C.), a system comprising a stainless steel vacuum insulated container with an internal freezer component, optimally placed to be within the liquid body, is presented.

For a liquid volume of 250 ml, the total weight of such a system is about 300 grams. The wall thickness of the stainless steel plus vacuum is only 5 mm. Some additional volume, maximum of 50 ml, is required for the freezer component. So the bottle, with a total capacity of 300 ml, is very similar to a regular drink bottle. The design is very simple and to the method of manufacturing is well known within the industry. Tests were done with 250 ml as it was considered the optimal amount for a child's lunch drink.

Such a system, since it works for a small volume of liquid, will function for any desired greater volume of liquid. Larger volumes of liquid will remain cold longer due to the larger initial thermal mass.

In accordance with an aspect of the present invention there is provided a drink bottle for comprising a double walled vacuum container, a lid for engaging and sealing the container, a freezer component sized to be received by the container and a -standoff coupling the freezer component to the lid for immersion in a liquid held in the container for maintaining the liquid at a temperature within a predetermined range for a predetermined period of time.

The present invention provides a stainless steel vacuum drink container able to keep liquids at a refrigerated state for a minimum of 5-10 hrs, dependent on the insulation properties of the container, the size and shape of the container, and the amount of refrigerant gel in the freezable insert optimally placed within the container. The size of the container opening, to which the lid attaches, is a significant factor in how long the drink is kept cold. If the opening is 50% larger in area, it may reduce the number of hours the drink is kept refrigerated by half. The amount of frozen gel is also very significant. Doubling the amount of frozen gel may double the number of hours the drink is kept refrigerated. (see FIG. 5)

Preferably, the freezable component freezes at 32° F. (0° C.) so that the liquid does not itself freeze, which is important for liquids such as milk.

Advantageously, the freezable component is positioned within the liquid such that it is not proximate to any of the container's walls or lid. This ensures that the insert primarily cools the liquid rather than the container walls, which having direct connection to the exterior provide a path of thermal loss. The bulk of the freezable insert is submerged in the liquid. The freezable insert is held in place by an attachment to the lid.

Advantageously, the freezable component is the minimum required volume because all of the thermal energy stored in it is used to cool the liquid, and loss directly to the environment is minimal.

Advantageously, the drink container of the present invention that will keep perishable liquids, such as milk, in a refrigerated state for prolonged time.

### BRIEF DESCRIPTION OF THE DRAWINGS

The present invention will be further understood from the following detailed description with reference to the drawings in which:

FIG. 1 graphically illustrates the known temperature ranges for bacterial growth;

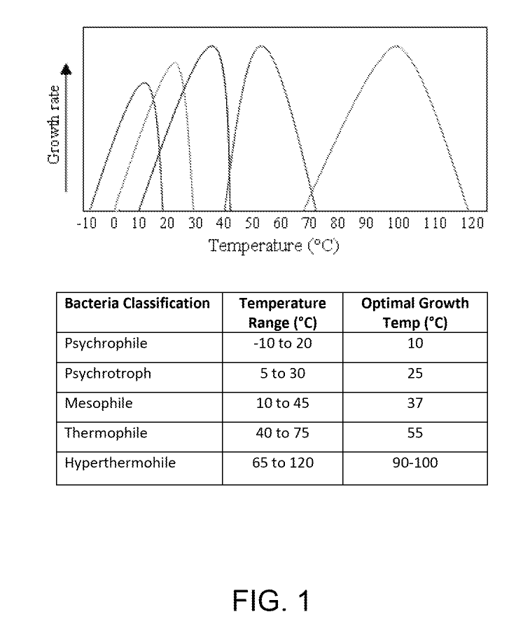

FIG. 2 graphically illustrates the temperature rises as a function of time for various prior art containers;

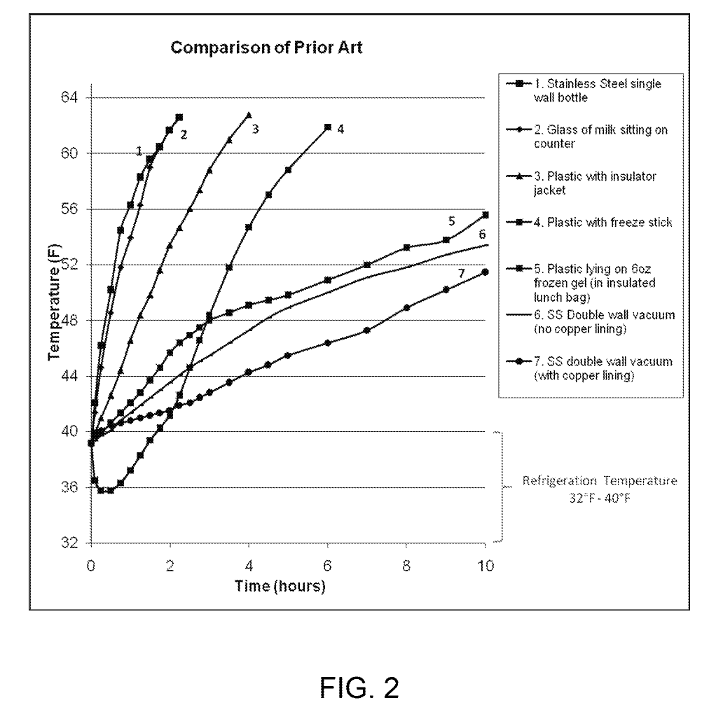

FIG. 3 illustrates a drink bottle in accordance with an embodiment of the present invention; and

FIG. 4 graphically illustrates the temperature rises as a function of time for the embodiment of FIG. 3 compared to that of various prior art containers.

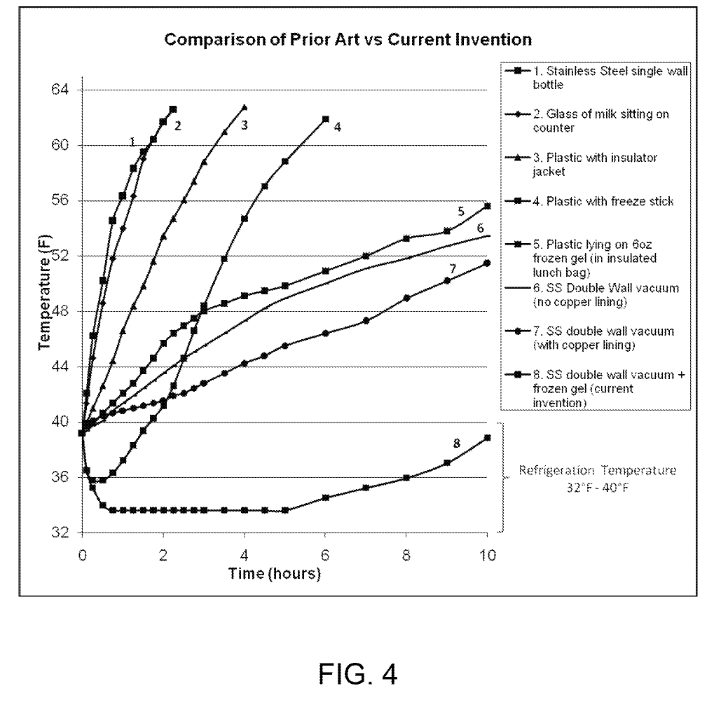

FIG. 5 graphically illustrates the temperature rise as a function of time for two different amounts of freezer gel in the freezable insert.

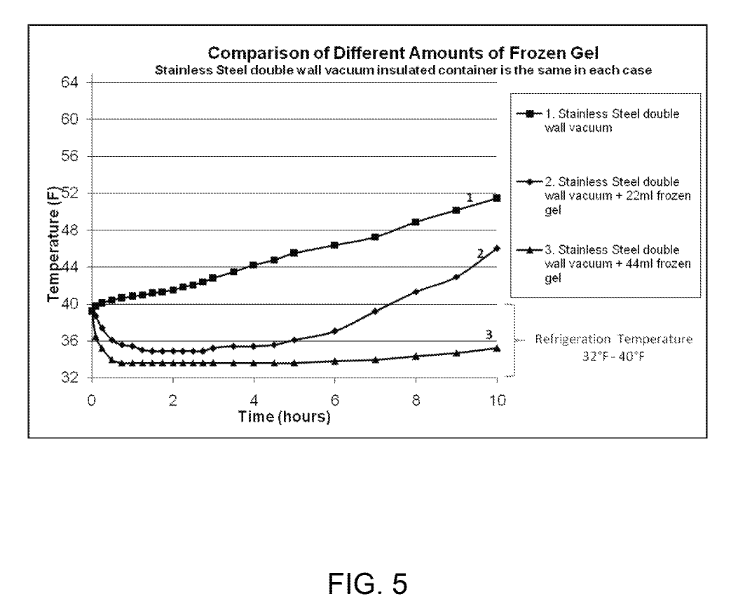

### DETAILED DESCRIPTION OF THE PREFERRED EMBODIMENT

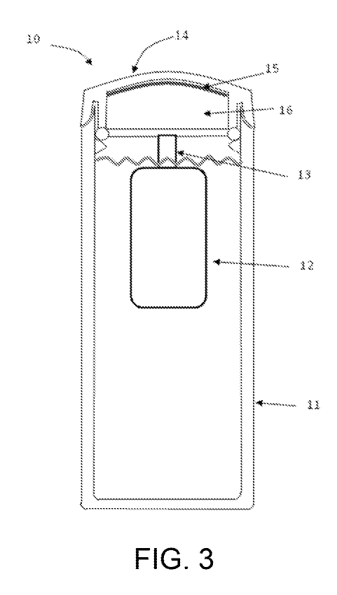

Referring to FIG. 3 there is illustrated a drink bottle in accordance with an embodiment of the present invention. The drink bottle includes a double walled stainless steel vacuum container 11, a freezer component 12, an insulating standoff 13, a lid 14, an aluminum radiation shield 15, and a sealed air insulation portion of the lid 16. The freezer component 12 is sized to provide sufficient thermal mass to provide a desired temperature range profile for a predetermined time period. The freezer component 12 is positioned by the standoff 13 to minimize heat conduction to the freezable insert and to ensure total immersion in the liquid whose temperature is to be maintained. The aluminum radiation shield may be added within the lid to reduce thermal loss due to radiation. This may result in ˜2° F. (1° C.) difference over 6 hrs.

The exterior container 11, a stainless steel double wall vacuum insulated bottle, is of known prior art (for example U.S. Pat. No. 5,153,977). Any double walled vacuum bottle will achieve results with varying success dependent on the quality of the insulator container. Stainless steel double wall vacuum insulated bottles will vary in their ability to achieve the desired results dependent on the quality of vacuum obtained within the walls and whether the stainless steel has an interior copper lining (see U.S. Pat. No. 4,427,123). The design of the bottle lid is also of great importance for achieving the desired temperature control. However, the results obtained were with commercially available bottle lids. Hence, any improvements to the lid, beyond that already available, will either reduce the amount of freezer component required, or extend the time that the liquid is kept cold.

The freezer component 12 is attached to the lid of the container via a standoff 13 that is of minimal diameter but sufficiently rigid to maintain its position in the liquid. The shaft is small in diameter to minimize the thermal loss along the shaft to the lid and external environment. The surface area of the freezer component is within the liquid, and does not have any surface adjacent to an external wall. By placing the bulk of the freezer component within the liquid, and not proximate to any exterior wall, the milk must be cooled before the external wall is cooled. This is the best way to ensure that the thermal energy of the freezer component is used in cooling the milk and not lost to the external environment via the lid or the walls.

The freezer component may contain a gel or water/salt solution which freezes at 32° F. (0° C.). The amount of such will be dependent on the amount of time that the liquid is expected to remain below a certain temperature. To maintain a temperature of below 40° F. (4° C.) for up to 10 hrs, with an exterior ambient temperature of 70° F. (21° C.), the amount of gel needed is between 30 to 50 ml.

Numerous modifications, variations and adaptations may be made to the particular embodiments described above without departing from the scope of the patent disclosure, which is defined in the claims.

What is claimed is:

1. A drink bottle comprising:
a double walled vacuum container;
a lid for engaging and sealing the container;
a freezer component sized to be received by the container; and
a standoff coupling the freezer component to the lid for immersion in a liquid held in the container for maintaining the liquid at a temperature within a predetermined range for a predetermined period of time.

2. A drink bottle as claimed in claim 1, wherein the double walled vacuum container is made of stainless steel.

3. A drink bottle as claimed in claim 1, wherein the freezer component includes a liquid that freezes at 32 degrees Fahrenheit (or 0 degrees Celsius).

4. A drink bottle as claimed in claim 1, wherein the freezer component included a gel that freezes at 32 degrees Fahrenheit (or 0 degrees Celsius).

5. A drink bottle as claimed in claim 1, wherein the predetermined temperature range is 34 to 40 degrees Fahrenheit (0 to 7 degrees Celsius).

6. A drink bottle as claimed in claim 1, wherein the predetermined period of time is 5 or more hours.

7. A drink bottle as claimed in claim 1, wherein the standoff is relatively small in diameter to minimize any thermal loss along the standoff to the lid.

8. A drink bottle as claimed in claim 1, wherein the container has a volume sufficient to hold 250 ml.

9. A drink bottle as claimed in claim 8, wherein:
the freezer component includes a gel that freezes at 32 degrees Fahrenheit (or 0 degrees Celsius); and
the amount of gel is between 30 to 50 ml.

10. A drink bottle as claimed in claim 1, wherein:
the freezer component includes a liquid that freezes at 32 degrees Fahrenheit (or 0 degrees Celsius) or a gel that freezes at 32 degrees Fahrenheit (or 0 degrees Celsius); and
the predetermined temperature range is 34 to 40 degrees Fahrenheit (0 to 7 degrees Celsius).

11. A drink bottle as claimed in claim 8, wherein:
the freezer component includes a liquid that freezes at 32 degrees Fahrenheit (or 0 degrees Celsius) or a gel that freezes at 32 degrees Fahrenheit (or 0 degrees Celsius); and
the predetermined period of time is 5 or more hours.

12. A drink bottle as claimed in claim 8, wherein:
the freezer component includes a liquid that freezes at 32 degrees Fahrenheit (or 0 degrees Celsius) or a gel that freezes at 32 degrees Fahrenheit (or 0 degrees Celsius); and
the standoff is relatively small in diameter to minimize any thermal loss along the standoff to the lid.

13. A drink bottle as claimed in claim 12, wherein the predetermined temperature range is 34 to 40 degrees Fahrenheit (0 to 7 degrees Celsius).

14. A drink bottle as claimed in claim 13, wherein the predetermined period of time is 5 or more hours.

15. A drink bottle as claimed in claim 14, wherein the container has a volume sufficient to hold 250 ml.

16. A drink bottle as claimed in claim 15, wherein the amount of gel or liquid is between 30 to 50 ml.

17. A drink bottle as claimed in claim 16, wherein the double walled vacuum container is made of stainless steel.

18. A method of manufacturing a drink bottle, said method comprising:
providing a double walled vacuum container;
providing a lid for engaging and sealing the container;
providing a freezer component sized to be received by the container; and
coupling the freezer component to the lid such that the freezer component is disposed within the container when the lid engages the container.

19. A method of manufacturing a drink bottle as claimed in claim 18, wherein the step of coupling freezer component to the lid includes coupling the freezer component to the lid with a thermally insulating standoff.

20. A drink bottle comprising:
a double walled vacuum container;
a lid for engaging and sealing the container;
a freezer component sized to be received by the container; and
means for coupling the freezer component to the lid for immersion in a liquid held in the container for maintaining the liquid at a temperature within a predetermined range for a predetermined period of time.
